(19) United States
(12) Patent Application Publication
(10) Pub. No.: US 2025/0250204 A1
(43) Pub. Date: Aug. 7, 2025

(54) INTEGRALLY WATERPROOF FIBER CEMENT COMPOSITE MATERIAL

(71) Applicant: James Hardie Technology Limited, Dublin 2 (IE)

(72) Inventors: Noel Dones, Rancho Cucamonga, CA (US); Basil Naji, Upland, CA (US); Caidian Luo, Rancho Cucamonga, CA (US)

(21) Appl. No.: 19/189,079

(22) Filed: Apr. 24, 2025

Related U.S. Application Data
(63) Continuation of application No. 17/290,648, filed on Apr. 30, 2021.
(60) Provisional application No. 62/756,811, filed on Nov. 7, 2018.
(60) Provisional application No. 62/903,445, filed on Sep. 20, 2019.

(51) Int. Cl. C04B 20/00; C04B 20/10; C04B 28/02; C04B 40/00; C04B 111/27; E04F 13/14

(52) U.S. Cl. CPC C04B 20/0068; C04B 20/008; C04B 20/1051; C04B 28/02; C04B 40/0046; E04F 13/14; C04B 2111/27

(57) ABSTRACT

Integrally waterproof fiber cement composite materials including interior and exterior fiber cement articles for building structures are disclosed. Fiber cement formulations include small percentages of silica fume and silanol. Formulations may additionally include a cementitious binder, silica, and a density modifier such as calcium silicate or perlite. Advantageously, the addition of preselected small percentages of silica fume and silanol has been discovered to yield waterproofness at substantially lower concentrations of silica fume and silanol than would be required to yield waterproofness when using either silica fume or silanol alone.

### CROSS-REFERENCE TO RELATED APPLICATIONS

This application is a divisional of U.S. application Ser. No. 17/290,648, filed Apr. 30, 2021, entitled “INTEGRALLY WATERPROOF FIBER CEMENT COMPOSITE MATERIAL,” which is the U.S. National Phase of PCT/US2019/060097, filed Nov. 6, 2019, entitled “INTEGRALLY WATERPROOF FIBER CEMENT COMPOSITE MATERIAL,” which claims the benefit of U.S. Provisional Application Ser. No. 62/756,811, filed Nov. 7, 2018, entitled “INTEGRALLY WATERPROOF FIBER CEMENT COMPOSITE MATERIAL,” and U.S. Provisional Application Ser. No. 62/903,445, filed Sep. 20, 2019, entitled “FIBER CEMENT ARTICLES WITH COUNTERFEIT DETECTION FEATURES.” All of the above-listed applications are hereby incorporated by reference in their entirety and for all purposes.

### FIELD

The present disclosure generally relates to fiber cement composite materials, formulations, cladding systems, and methods of making the same.

### BACKGROUND

Fiber cement composite materials are frequently used to form exterior and/or interior surfaces of a building structure. Fiber cement-based cladding and interior boards have become popular alternatives to traditional materials in both residential and commercial construction. In some instances it may be desirable to provide additional waterproofing to fiber cement boards that are exposed to long-term excess moisture. For example, some may wish to apply a plastic sheet, wrap material, or other waterproof membranes to the exterior surfaces of fiber cement interior boards that are used as a tile underlayment for wet areas such as kitchens and bathrooms. When additional waterproofing is desired, the waterproof membrane is typically applied in the field, which requires additional work from the installer and builder and may not yield consistent results.

### SUMMARY

The present disclosure provides an integrally waterproof fiber cement composite material that provides a high level of waterproofness comparable to equivalent fiber cement composite materials with additional waterproof membranes. Various embodiments of the integrally waterproof fiber cement composite material formulation incorporate a combination of predetermined quantities of silanol and silica fume which when reacted with other components of the formulation impart unexpectedly high waterproofness to the fiber cement composite material. Contrary to conventional understandings of water resistance in fiber cement, the formulation incorporates extremely small percentages of silanol and silica fume which unexpectedly provide better waterproof performance than formulations that include much higher percentages of silanol or silica fume. The integrally waterproof fiber cement composite material made in accordance with various formulations disclose herein meets or exceeds the criteria of ASTM D4068 hydrostatic pressure test (e.g., the ASTM D4068—17 version, revised in 2017) without applying any additional waterproof membranes. Hereinafter, the term “ASTM D4068 hydrostatic pressure test (e.g., the ASTM D4068-17 version, revised in 2017)” may be referred to as ASTM D4068 hydrostatic pressure test, ASTM D4068 hydrostatic test, ASTM D4068 test, or ASTM D4068 test for waterproofness without limitation.

In one embodiment, the integrally waterproof fiber cement composite material formulation comprises between 25% and 29% by weight of a cementitious binder; between 50% and 60% by weight of silica; between 6.5% and 7.5% by weight of cellulose fibers, between 2.5% and 3% by weight of alumina; between 5% and 6% by weight of a density modifier such as calcium silicate and/or perlite; and between 0.25% and 1% by weight of silica fume having a particle size smaller than 150 μm. The integrally waterproof fiber cement composite material formulation further comprises silanol having a dry weight less than 1% of the dry weight of the cellulose fibers. The silanol and cellulose fibers are pre-dispersed in a solution prior to mixing with the remaining components of the formulation. In some embodiments, the silanol in the pre-dispersed solution has a dry weight equal to approximately 0.5% of the dry weight of the cellulose fibers.

In some embodiments, the integrally waterproof fiber cement composite material formulation includes approximately 0.5% by weight of silica fume. In some embodiments, the integrally waterproof fiber cement composite material can be an interior board for a building structure or an exterior cladding such as siding. In some embodiments, the integrally waterproof fiber cement composite material is sufficiently waterproof to prevent droplet formation when exposed to hydrostatic pressure from a 2″ wide×20″ tall column of water for 48 hours. For example, the integrally waterproof fiber cement composite material may pass the ASTM D4068 hydrostatic pressure test (e.g., the ASTM D4068—17 version, revised in 2017).

In another embodiment, the integrally waterproof fiber cement composite material formulation comprises a cementitious hydraulic binder; silica; silica fume, wherein the silica fume comprises between 0.25% and 2% of the dry weight of the material formulation; and cellulose fibers, at least some of the cellulose fibers having surfaces that are at least partially treated with a sizing agent to make the surfaces hydrophobic. The dry weight of the sizing agent is between 0.25% and 2% of the weight of the cellulose fibers.

In some embodiments, the silica fume comprises approximately 0.5% of the dry weight of the material formulation. In some embodiments, the sizing agent comprises a silanol solution. In some embodiments, the silanol solution comprises a dispersant. In some embodiments, the dry weight of the sizing agent is approximately 0.5% of the weight of the cellulose fibers. In some embodiments, the integrally waterproof fiber cement composite material formulation further comprises a density modifier. In some embodiments, the density modifier comprises perlite and/or calcium silicate. In some embodiments, the integrally waterproof fiber cement composite material is sufficiently waterproof to prevent droplet formation when exposed to hydrostatic pressure from a 2″ wide×20″ tall column of water for 48 hours. For example, the integrally waterproof fiber cement composite material may pass the ASTM D4068 hydrostatic pressure test (e.g., the ASTM D4068-17 version, revised in 2017).

In other embodiments, a method of manufacturing an integrally waterproof fiber cement composite material comprises mixing cellulose fibers with a diluted silanol solution, wherein the silanol solution comprises an amount of silanol between 0.25% and 2% of the dry weight of the cellulose fibers; preparing a formulation comprising a cementitious hydraulic binder and silica; adding to the formulation the mixed cellulose fibers and silanol solution; adding to the formulation a relatively small quantity of silica fume, wherein the silica fume comprises between 0.25% and 2% of the dry weight of the formulation; and curing the formulation for a time sufficient to cause the material to set.

In some embodiments, the cellulose fibers are mixed with the silanol solution for between 1 and 10 minutes before being added to the formulation. In some embodiments, the silanol solution comprises a dispersant. In some embodiments, the formulation further comprises a density modifier comprising at least one of perlite and calcium silicate. In some embodiments, the method further comprises, prior to curing the formulation, forming the formulation into one or more substantially planar articles using a Hatschek process. In some embodiments, the substantially planar articles can be an interior board or an exterior cladding for a building structure.

In another embodiment, an integrally waterproof fiber cement composite material comprises between 35% and 39% by weight of a cementitious binder; between 40% and 50% by weight of silica; approximately 8.25% by weight of cellulose fibers, wherein the fibers have surfaces that are treated with a small amount of silanol in a diluted pre-dispersed solution, the silanol having a dry weight less than 1% of the dry weight of the cellulose fibers; approximately 3% by weight of alumina; between 5% and 6% by weight of a density modifier comprising at least one of calcium silicate and perlite; and between 0.25% and 1% by weight of silica fume having a particle size smaller than 150 μm.

In some embodiments, the silanol in the diluted pre-dispersed solution have a dry weight equal to approximately 0.5% of the dry weight of the cellulose fibers. In some embodiments, the integrally waterproof fiber cement composite material includes approximately 0.5% by weight of silica fume. In some embodiments, the integrally waterproof fiber cement composite material is an interior board or an exterior cladding. In some embodiments, the integrally waterproof fiber cement composite material is sufficiently waterproof to prevent droplet formation when exposed to hydrostatic pressure from a 2″ wide×20″ tall column of water for 48 hours and meets the criteria of the ASTM D4068 hydrostatic pressure test (e.g., the ASTM D4068—17 version, revised in 2017).

In some embodiments, the present disclosure provides a building system comprising: a first water resistant layer secured to a surface of a building substrate; a first building article comprising a front face, a rear face opposite the front face, and an edge member disposed contiguously between the front face and the rear face, wherein the edge member defines a first side of the first building article, wherein the first building article is secured to the first water resistant layer and the building substrate through the first weather resistant layer such that the rear face is in contact with the first water resistant layer; a second building article comprising a front face, a rear face opposite the front face, and an edge member disposed contiguously between the front face and the rear face, wherein the edge member defines a second side of the second building article, wherein the second building article is secured to the first water resistant layer and the building substrate through the first water resistant layer such that the rear face is in contact with the first water resistant layer; wherein the first and second building articles are secured to the first water resistant layer and the building substrate such that the first and second sides of the first and second building articles are positioned adjacent one another along an abutment line; and a second water resistant layer secured to portions of the front faces of the first and second building articles along the abutment line to prevent liquid from traveling past the first and second sides of the first and second building articles to the first water resistant layer and the building substrate.

In some embodiments, the first and second building articles comprise recessed portions extending along the first and second sides proximate to the abutment line, and wherein the second water resistant layer is positioned within the recessed portions of the first and second building articles. In some embodiments, the second water resistant layer comprises a thickness and the recessed portions of the first and second building articles each comprise a depth that is substantially equal to the thickness of the second water resistant layer such that, when the second water resistant layer is positioned within the recessed portions, a surface of the second water resistant layer is substantially planar with the front faces of the first and second building articles. In some embodiments, the recessed portions of the first and second building articles are tapered. In some embodiments, the second water resistant layer comprises a waterproof tape. In some embodiments, the building system further comprises a mesh layer secured to the front faces of the first and second building articles along the abutment line, wherein the mesh layer is positioned between the second water resistant layer and the front faces of the first and second building articles. In some embodiments, the second water resistant layer comprises a cementitious material. In some embodiments, the first water resistant layer comprises butyl tape. In some embodiments, the first water resistant layer is adhered to the building substrate. In some embodiments, the first and second building articles comprise fiber cement. In some embodiments, the first and second building articles each comprise a plurality of integrally formed drainage channels and a plurality of spacer sections disposed between the drainage channels, each of the plurality of drainage channels defining an air gap comprising a liquid flow path. In some embodiments, the plurality of integrally formed drainage channels and the plurality of spacer sections are disposed on the front faces of the first and second building articles.

In another embodiment, the present disclosure provides a building system comprising: a building substrate; a first building article comprising a front face, a rear face opposite the front face, and an edge member disposed contiguously between the front face and the rear face, wherein the first building article is secured to the building substrate such that the rear face is positioned closer to the building substrate than the front face, and wherein at least one of the front and rear faces comprises a plurality of integrally formed drainage channels and a plurality of spacer sections disposed between the drainage channels, each of the plurality of drainage channels defining an air gap comprising a liquid flow path; a first building panel secured to the first building article and the building substrate such that the first building panel contacts the front face of the first building article; and a plurality of fasteners configured to secure the first building article and the first building panel to the building substrate.

In some embodiments, the plurality of drainage channels and the plurality of spacer sections are located on the front face of the first building article. In some embodiments, the first building article comprises fiber cement, and wherein the first building panel comprises fiber cement. In some embodiments, the building system further comprises: a second building article comprising a front face, a rear face opposite the front face, and an edge member disposed contiguously between the front face and the rear face, wherein the second building article is secured to the building substrate such that the rear face is positioned closer to the building substrate than the front face, and wherein at least one of the front and rear faces comprises a plurality of integrally formed drainage channels and a plurality of spacer sections disposed between the drainage channels, each of the plurality of drainage channels defining an air gap comprising a liquid flow path; and a second building panel secured to the second building article and the building substrate such that the second building panel contacts the front face of the second building article; wherein the plurality of fasteners are further configured to secure the second building article and the second building panel to the building substrate. In some embodiments, the first building panel comprises a first edge and the second building panel comprises a second edge, and wherein each of the first and second building panels are secured to a different one of the first and second building articles such that an express joint exists between the first and second edges of the first and second building panels. In some embodiments, the first building panel is an insulation panel. In some embodiments, the building system further comprises a mesh layer and a coating layer, wherein the insulation panel is positioned between the mesh layer and the first building article, and wherein the mesh layer is positioned between the coating layer and the insulation panel. In some embodiments, the building system further comprises a coating layer, wherein the insulation panel is positioned between the coating layer and the first and second building articles.

In some embodiments, the present disclosure provides various fiber cement composite articles that include counterfeit detection features including pigmented layers disposed between adjacent laminated layers of fiber cement material. The counterfeit detection features disclosed herein provide a number of advantageous and unexpected features. For example, the pigmented layers may be applied in solution in a liquid carrier without bleeding into the adjacent fiber cement layers, regardless of whether the pigment solution is applied to wet (uncured) or dry (cured) fiber cement. In another example unexpected advantage, the pigmented layers may be invisible at the edges of a fiber cement article when the article is cut by water jet cutting, but may be visible at the edges of the article when the article is cut by a saw.

In one embodiment, a fiber cement article comprises a first major face, a second major face opposite the first major face, and an intermediate portion disposed between the first major face and the second major face. The intermediate portion comprises a plurality of laminated layers of fiber cement, and one or more pigmented layers disposed between adjacent layers of the plurality of laminated layers, the one or more pigmented layers having a different color relative to the plurality of laminated layers.

In some embodiments, the one or more pigmented layers comprise particles of a pigment having an average particle size smaller than approximately 50 micron. In some embodiments, the pigment has an average particle size of between approximately 1 micron and approximately 10 micron. In some embodiments, the pigment has an average particle size of between approximately 2.5 micron and approximately 7.5 micron. In some embodiments, the one or more pigmented layers comprise an inorganic pigment. In some embodiments, the inorganic pigment comprises at least one of an iron oxide, an aluminum oxide, a silicon oxide, or a titanium oxide. In some embodiments, the inorganic pigment comprises a red iron oxide. In some embodiments, the plurality of laminated layers of fiber cement each comprise a cementitious hydraulic binder, silica, cellulose fibers, and additives. In some embodiments, the plurality of laminated layers of fiber cement are integrally waterproof fiber cement comprising a cementitious hydraulic binder, silica, a pozzolanic material, and cellulose fibers. The pozzolanic material comprises between 0.25% and 2% of the dry weight of the integrally waterproof fiber cement. At least some of the cellulose fibers have surfaces that are at least partially treated with a hydrophobic agent to make the surfaces hydrophobic, wherein the dry weight of the hydrophobic agent is between 0.25% and 2% of the weight of the cellulose fibers. In some embodiments, the intermediate portion comprises at least three laminated layers of fiber cement and at least two pigmented layers, and one of the pigmented layers is disposed between each adjacent pair of laminated layers of fiber cement. In some embodiments, the one or more pigmented layers are visible along a cut edge of the fiber cement article when the fiber cement article is cut by a saw perpendicular to the first and second major faces, and the one or more pigmented layers are not visible along the cut edge of the fiber cement article when the fiber cement article is cut by a water jet perpendicular to the first and second major faces.

In another embodiment, a method of manufacturing a fiber cement article comprises forming a first laminate layer of cementitious slurry; applying a pigment suspension to a first surface of the first laminate layer, the pigment suspension comprising pigment solids suspended in a liquid carrier; forming a second laminate layer of cementitious slurry over the pigment suspension such that the pigment suspension is disposed between the first laminate layer and the second laminate layer; and curing the first and second laminate layers and the pigment suspension to form the fiber cement article comprising a cured pigmented layer disposed between two layers of cured fiber cement.

In some embodiments, the pigment suspension comprises an aqueous suspension including particles of a pigment having an average particle size smaller than 50 micron. In some embodiments, the pigment has an average particle size of between approximately 1 micron and approximately 10 micron. In some embodiments, the pigment has an average particle size of between approximately 2.5 micron and approximately 7.5 micron. In some embodiments, the pigment suspension comprises an inorganic pigment. In some embodiments, the inorganic comprises at least one of an iron oxide, an aluminum oxide, a silicon oxide, or a titanium oxide. In some embodiments, the inorganic pigment comprises a red iron oxide. In some embodiments, the first laminate layer and the second laminate layer are formed by first and second sequential passes over one or more sieve cylinders in a Hatschek process. In some embodiments, the pigment suspension is applied between the first and second sequential passes by depositing the pigment suspension onto a surface of the first laminate layer by one or more of a spray or a slot die, or by passing at least a portion of the first laminate layer through a container of the pigment suspension. In some embodiments, the method further comprises, prior to the curing, applying a second layer of the pigment suspension to a first surface of the second laminate layer, and forming a third laminate layer of cementitious slurry over the second layer of the pigment suspension such that the second layer of the pigment suspension is disposed between the second laminate layer and the third laminate layer. The curing simultaneously cures the first, second, and third laminate layers and the pigment suspension to form the fiber cement article comprising two cured pigmented layers alternately disposed between three layers of cured fiber cement.

### BRIEF DESCRIPTION OF THE DRAWINGS

Certain embodiments of the present disclosure will now be described, by way of example only, with reference to the accompanying drawings. From figure to figure, the same or similar reference numerals are used to designate similar components of an illustrated embodiment.

FIG. 1 is a partially cut-away sectional view of another embodiment of a building system.

FIG. 2 is a partially cut-away sectional view of another embodiment of a building system.

FIG. 3A is a partially cut-away sectional view of another embodiment of a building system.

FIG. 3B is an enlarged front view of a building article of the building system of FIG. 3A.

FIG. 3C is an enlarged cross-sectional view of a portion of the building article of FIG. 3B.

FIG. 4 is a partially cut-away sectional view of another embodiment of a building system.

FIG. 5 is a partially cut-away sectional view of another embodiment of a building system.

FIG. 6 is a side view of an edge of an example fiber cement article including counterfeit detection features after water jet cutting.

FIG. 7 is a side view of an edge of an example fiber cement article including counterfeit detection features after saw cutting.

### DETAILED DESCRIPTION

Disclosed herein are integrally waterproof fiber cement composite materials that exhibit unexpectedly high waterproofness characteristics due to the inclusion of small percentages of a combination of silica fume and silanol in conjunction with the other components. The quantities of silica fume and silanol that have been found to yield superior waterproof properties can be at least an order of magnitude smaller than the respective quantities of silica fume or silanol that would be required to produce a waterproof material. The amounts of silanol or silica fume necessary to produce a waterproof fiber cement composite material, if included individually, are large enough as to cause undesirable side effects during production. Accordingly, the combination of silica fume and silanol in the small percentages disclosed herein advantageously provide cost savings and allow commercial production of integrally waterproof fiber cement composite materials.

As will be described in greater detail, the synergistic combinations of predetermined amounts of silanol and silica fume disclosed herein can yield integrally waterproof fiber cement composite materials at significantly lower combined dosages than would be required of either component individually. For example, it has been discovered that the inclusion of silica fume in a fiber cement formulation at only 0.5% by weight reduces the amount of silanol required to produce an integrally waterproof fiber cement composite material by approximately 90% (e.g., from approximately 5% of cellulose fiber dry weight to approximately 0.5% of cellulose fiber dry weight).

### Example Fiber Cement Composite Material Compositions

Embodiments of fiber cement composite material compositions generally include a cementitious hydraulic binder, such as Portland cement or any other suitable cement, silica, and fibers, such as cellulose or other suitable fibers. The fiber may include a blend of two or more types of fibers, and may include recycled fiber materials. In some embodiments, the fiber is added in the form of a pulp, such as wood pulp or the like. The fiber cement composite materials may further include additional components such as silica, alumina, coloring additives, or the like. One or more density modifiers, such as low density additives, may further be included. Coloring additives may include, for example, pigments such as red or pink clay, or the like. Density modifiers may include, for example, low-density additives such as calcium silicate, perlite, or the like. The components of a fiber cement composite material formulation may be mixed in a slurry form including water, and may be formed into fiber cement composite materials by any of various processes such as a Hatschek process or the like. Water content may be removed from the fiber cement composite materials by various curing methods including autoclaving or the like, to form solid fiber cement composite materials.

In various formulations, the cement may comprise between 20% and 45% of the dry weight of the slurry. For example, the cement may comprise between 25% and 39% of dry weight, between 25% and 29% of dry weight, between 35% and 39% of dry weight, or any percentage within the preceding ranges. Cement content less than 20% or greater than 45% is similarly possible. In some embodiments, a relatively lower cement content, such as between 25% and 29% of dry weight, may be desirable for interior cladding articles, interior board, or the like. In some embodiments, a relatively higher cement content, such as between 35% and 39% of dry weight, may be desirable for exterior cladding articles. It will be understood that each of the cement contents or cement content ranges disclosed herein may be reduced by an amount of silica fume added to the formulation. For example, a baseline cement content of between 25% and 39% of dry weight may correspond to an actual cement content of between 23% and 37% of dry weight if 2% by weight of silica fume is included in the formulation.

In various formulations, cellulose fibers may comprise between 3% and 15% of dry weight of the slurry. For example, the cellulose fibers may comprise between 5% and 10% of dry weight, between 6% and 9% of dry weight, between 6.5% and 7.5% of dry weight, between 7.75% and 8.75% of dry weight, or any percentage within the preceding ranges. Cellulose fiber content less than 3% or greater than 15% is similarly possible. In some embodiments, a relatively lower cellulose fiber content, such as between 6.5% and 7.5%, or approximately 7% of dry weight, may be desirable for interior cladding articles, interior board, or the like. In some embodiments, a relatively higher cellulose fiber content, such as between 7.75% and 8.75%, or approximately 8.25% of dry weight, may be desirable for exterior cladding articles.

In various formulations, the silica may comprise any percentage between 50% and 60% of dry weight. For example, the silica may comprise approximately 50% of dry weight, 54% of dry weight, 56% of dry weight, 58% of dry weight, etc. In various formulations, the alumina may comprise any percentage between 2% and 5% of dry weight. For example, the alumina may comprise approximately 3% of dry weight, approximately 3.5% of dry weight, etc. In various formulations, the density modifier may comprise any percentage between 0% and 7% of dry weight. For example, some formulations may include no density modifier, or may include approximately 2% of dry weight, approximately 3% of dry weight, approximately 4% of dry weight, approximately 5% of dry weight, approximately 5.5% of dry weight, approximately 7% of dry weight, etc. Common density modifiers present in these quantities may include calcium silicate, perlite, or the like.

In some embodiments, additional components may be included as components in a fiber cement composite material, in addition to the components described above. For example, in some embodiments a fiber cement composite material formulation may include one or more components that cause water resistance or waterproofness of the finished fiber cement composite material. One example component is a sizing agent such as a silanol solution, which may include silanol and water or another suitable solvent. Without being bound by theory, it is understood that silanols increase water resistance because they act as sizing agents making the surfaces of the fibers hydrophobic and, when used to treat fiber cement fibers, prevent water from traveling through the fiber cement matrix along the edges of the fibers. In some embodiments, a silanol solution may be mixed with the fiber component of the fiber cement formulation. The silanol solution may be added to the fibers at the time the fiber is mixed with the remaining components of the fiber cement formulation, or may be pre-mixed with the fiber (e.g., for 1 minutes, 5 minutes, 10 minutes, 20 minutes, or more) prior to adding the remaining components of the fiber cement formulation. Quantities of silanol solution to be added to the fibers may be determined such that the silanol have a dry weight of approximately 0.25% of fiber dry weight, approximately 0.5% of fiber dry weight, approximately 1% of fiber dry weight, approximately 2% of fiber dry weight, approximately 3% of fiber dry weight, approximately 4% of fiber dry weight, approximately 5% of fiber dry weight, or more. The dry weight of the silanol may be in any suitable range such as between 0.25% and 3% of fiber dry weight, between 0.25% and 2% of fiber dry weight, between 0.25% and 1% of fiber dry weight, or any sub-range therebetween.

Silica fume is another example component that may be included in some fiber cement composite material formulations. Silica fume is a fine pozzolanic material comprising amorphous silica. Silica fume may be produced, for example, as a byproduct of the production of elemental silicon or ferro-silicon alloys in electric arc furnaces. Silica fume may be included in a variety of concrete and cementitious products, but is not typically used for waterproofing implementations. However, it has been discovered that silica fume may enhance the water resistance of fiber cement composite materials and may yield integrally waterproof fiber cement composite materials when included in conjunction with silanol. Without being bound by theory, it is believed that the relatively fine size of silica fume, relative to the other components of a fiber cement article, may reduce porosity of the cementitious matrix between fibers. Moreover, silica fume can conveniently be added to fiber cement formulations as a replacement for a portion of the cement. For example, in some embodiments the cement component of the fiber cement may be reduced by an equal weight to the weight of silica fume added to the formulation, without undesirably affecting other physical properties of the fiber cement articles such as dimensional stability, flexural strength, or the like. In various formulations, the amount of silica fume in a fiber cement article may be, for example, between 0.25% and 5% of dry weight, between 0.25% and 4% of dry weight, between 0.25% and 3% of dry weight, between 0.25% and 2% of dry weight, between 0.25% and 1% of dry weight, or any sub-range or percentage therebetween. For example, in some embodiments, the silica fume content is approximately 0.5% of dry weight, approximately 1% of dry weight, approximately 1.5% of dry weight, approximately 2% of dry weight, etc. However, relatively large quantities of silica fume (e.g., above 2-3% of dry weight) may interfere with commercial-scale production of fiber cement composite materials.

### Results of Waterproofness and Surface Wetness Testing

As will be described in greater detail, various fiber cement composite material formulations were tested to investigate the unexpected synergy of sizing agents and pozzolanic materials. In a first trial, control fiber cement specimens and specimens formulated using either silanol or silica fume (but not both) were tested to evaluate how much of either additive would be required (if even possible) to yield a waterproof fiber cement composite material. Second and third trials evaluated formulations including both silanol and silica fume in decreasing quantities to evaluate the extent of synergy by determining how little of each additive could be included in combination while still yielding an integrally waterproof fiber cement composite material. A fourth trial evaluated the effects of certain variations in the manufacturing processes disclosed herein.

Testing for waterproofness was performed using the ASTM D4068 hydrostatic test. A standard waterproofing test has not been established for tiled interior boards. However, the industry typically uses the ASTM D4068 hydrostatic test to assess waterproofness of waterproof membrane materials such as chlorinated polyethylene (CPE) or the like. Accordingly, specimens of the fiber cement compositions disclosed here were subjected to the ASTM D4068 test to provide a similar indication of waterproofness. The example revision of the test used to test the specimens was the ASTM D4068—17 version, revised in 2017.

ASTM D4068 hydrostatic pressure test is a pass-fail test. A specimen is exposed to surface pressure from a column of water 2 feet (60.96 cm) high and 2 inches (5.08 cm) in diameter. The specimen is exposed to the water surface pressure for 48 hours. After 48 hours of exposure, the specimen passes the test and can be considered waterproof if there is no evidence of water droplet formation on the opposite side (e.g., the underside) of the specimen. Evidence of water droplet formation (e.g., due to water seeping through the specimen below the water column) results in a failure of the waterproofness test.

In addition to the pass-fail result of the ASTM D4068 hydrostatic pressure test based on presence or lack of droplet formation, specimens of the fiber cement compositions were tested with a moisture meter to quantify surface wetness of the side of each specimen opposite the water column. The moisture meter provides a measurement of electrical conductivity along the surface of the specimen between two electrodes at a predefined spacing. Because electrical conductivity of the cementitious article increases in proportion to the presence of water along the conductive path between the electrodes, the determined conductivity can provide a reliable indication of surface wetness.

### Trial 1

In a first trial, various sample specimens of fiber cement composite materials were produced and tested using the ASTM D4068 hydrostatic pressure test. The specimens tested in the first trial included control specimens including neither silanol nor silica fume, and specimens produced using either silanol or silica fume. A calcium silicate control specimen was formulated with cement comprising 28.70% of dry weight, silica comprising 55.80% of dry weight, cellulose fiber comprising 7.00% of dry weight, alumina comprising 3.00% of dry weight, and calcium silicate comprising 5.50% of dry weight. 1% silica fume, 2% silica fume, and 6% silica fume specimens were formulated based on the above calcium silicate control formulation, by adding silica fume in quantities of 1%, 2%, and 6% of dry weight, respectively, and reducing the quantity of cement by an equal weight. 3% silanol, 4% silanol, and 5% silanol specimens were formulated based on the above calcium silicate control formulation, by mixing the cellulose fiber with a silanol-dispersant solution in quantities of 3%, 4%, and 5% of fiber dry weight, respectively, before adding the remaining components. A perlite control specimen was formulated with 30.20% cement, 53.90% silica, 7.00% cellulose fiber, 3.00% alumina, and 5.90% perlite. A 4% silica fume specimen was formulated based on the perlite control formulation by adding 4% dry weight of silica fume (2% mixed with the cellulose fiber prior to adding the remaining components and 2% added with the remaining components) and reducing the quantity of cement by 4% dry weight. A 5% silanol specimen was formulated based on the above perlite control formulation by mixing the cellulose fiber with 5% fiber dry weight of the silanol-dispersant solution before adding the remaining components. After mixing, each specimen formulation was cured in an autoclave.

For the above formulations including silica fume, the silica fume was prepared as follows. The silica fume was received in a densified and agglomerated form. The silica fume was wet-out and dispersed in a 50% solids solution with fresh water for 10 minutes in a shear mixer. Particle size of the silica fume before mixing, after 1 minutes of mixing, and after 10 minutes of mixing is shown in Table 2 below.

TABLE 1
Silica fume particle size

| | Silica Fume 0 m | Silica Fume l m | Silica Fume 10 m |
|---|---|---|---|
| Median particle | 12.92 | 13.39 | 3.75 |
| size (μm) | | | |
| Mean particle | 31.42 | 26.92 | 9.69 |
| size (μm) | | | |
| % Passing 10 μm | 38.04 | 38.39 | 69.68 |
| % Passing 40 μm | 87.52 | 86.74 | 94.63 |
| % Passing 150 μm | 96.26 | 96.26 | 100.0 |

For the above formulations including a silanol-dispersant solution, the silanol-dispersant solution was prepared as follows. A silanol solution of 88% solids was obtained. A dispersant aid was mixed with water to achieve 10% solids and mixed for 3 hours. The dispersant aid solution was mixed with the silanol solution in a quantity of 2% solids and mixed for 5 minutes.

Each formulation above was subjected to a 48-hour ASTM D4068 test. The results of the ASTM D4068 test are shown in Table 2 below.

TABLE 2
Results of ASTM D4068 testing of example fiber cement specimens

| Formulation | Result |
|---|---|
| Calcium silicate control | Fail |
| Calcium silicate-1% silica fume | Fail |
| Calcium silicate-2% silica fume | Fail |
| Calcium silicate-6% silica fume | Fail |
| Calcium silicate-3% silanol | Fail |
| Calcium silicate-4% silanol | Fail |
| Calcium silicate-5% silanol | Pass |
| Perlite control | Fail |
| Perlite-4% silica fume | Fail |
| Perlite-5% silanol | Fail |

Following the ASTM D4068 test, the specimens were further tested with a moisture meter to determine surface wetness. For each formulation, electrical conductivity (proportional to surface wetness) was measured for the surface opposite the column of water used for the ASTM D4068 test. The conductivity values were measured in a dimensionless scale corresponding to the moisture meter, and consistent across all samples. It was determined empirically that a conductivity value less than approximately 85 corresponds to a specimen passing the ASTM D4068 test (e.g., no droplet formation). Consistent with the results in Table 1 above, only the calcium silicate-5% silanol specimen had a conductivity value confidence interval lower than 85.

As shown in Table 1 above, only one of the ten specimens tested in the first trial passed the ASTM D4068 test for waterproofness. The passing specimen was the calcium silicate-5% silanol specimen. As described above, treating the cellulose fiber with 5% fiber dry weight of silanol-dispersant mixture would be undesirable for full-scale production of fiber cement composite materials due to various production difficulties associated with high levels of silanol. Moreover, while 5% silanol was sufficient for waterproofing in the calcium silicate formulation, 5% silanol did not yield a waterproof specimen in the perlite formulation. Thus, the first trial confirmed that neither silica fume alone nor silanol alone was suitable as a waterproofing additive in commercially feasible quantities.

### Trial 2

In a second trial, various sample specimens of fiber cement composite materials were produced and tested using the ASTM D4068 hydrostatic pressure test. The specimens tested in the second trial included a calcium silicate control specimen, calcium silicate specimens produced using either silanol or silica fume, and calcium silicate specimens produced using both silanol and silica fume. The calcium silicate control specimen was formulated with cement comprising 28.70% of dry weight, silica comprising 55.80% of dry weight, cellulose fiber comprising 7.00% of dry weight, alumina comprising 3.00% of dry weight, and calcium silicate comprising 5.50% of dry weight. 3% silica fume and 6% silica fume specimens were formulated based on the above calcium silicate control formulation, by adding silica fume in quantities of 3% and 6% of dry weight, respectively, and reducing the quantity of cement by an equal weight. 2% silanol and 4% silanol specimens were formulated based on the above calcium silicate control formulation, by mixing the cellulose fiber with a silanol-dispersant solution in quantities of 2% and 4% of fiber dry weight, respectively, before adding the remaining components. In addition, combination specimens were formulated based on the above calcium silicate control formulation by mixing the cellulose fiber with the silanol-dispersant solution and replacing cement with silica fume each of the four possible combinations of the silica fume and silanol specimens above (e.g., 3% silica fume-2% silanol, 3% silica fume-4% silanol, 6% silica fume-2% silanol, and 6% silica fume-4% silanol). After mixing, each specimen formulation was cured in an autoclave. For the above formulations including silica fume, the silica fume was prepared by the same method as in Trial 1, except that the silica fume was wet-out and dispersed in a 25% solids solution rather than 50% solids. For the above formulations including the silanol-dispersant solution, the silanol-dispersant solution was prepared by the same method as in Trial 1.

Each formulation above was subjected to a 48-hour ASTM D4068 test. The results of the ASTM D4068 test are shown in Table 3 below.

TABLE 3
Results of ASTM D4068 testing of example fiber cement specimens

| Formulation | Result |
|---|---|
| Calcium silicate control | Fail |
| Calcium silicate-3% silica fume | Fail |
| Calcium silicate-6% silica fume | Fail |
| Calcium silicate-2% silanol | Fail |
| Calcium silicate-4% silanol | Fail |
| Calcium silicate-2% silanol-3% silica fume | Pass |
| Calcium silicate-4% silanol-3% silica fume | Pass |
| Calcium silicate-2% silanol-6% silica fume | Pass |
| Calcium silicate-4% silanol-6% silica fume | Pass |

Following the ASTM D4068 test, the specimens were further tested with a moisture meter to determine surface wetness. For each formulation, electrical conductivity (proportional to surface wetness) was measured for the surface opposite the column of water used for the ASTM D4068 test. The conductivity values were measured in a dimensionless scale corresponding to the moisture meter, and consistent across all samples. It was determined empirically that a conductivity value less than approximately 85 corresponds to a specimen passing the ASTM D4068 test (e.g., no droplet formation). Consistent with the results in Table 3 above, each of the specimens including both silica fume and silanol had a conductivity value significantly lower than 85, while the control specimen and each of the specimens including only silica fume or silanol had a conductivity value of approximately 85 or higher.

As shown in Table 3 above, each of the specimens including both silica fume and silanol passed the ASTM D4068 test for waterproofness, while the remaining specimens showed evidence of droplet formation and failed the test. In addition, the ASTM D4068 test conditions were maintained for more than 8 weeks beyond the 48-hour test period, and the passing specimens continued to pass the waterproofness test criteria by not showing evidence of droplet formation. Notably, the quantities of silica fume and silanol-dispersant solution used in producing some of the passing specimens was substantially lower than the quantities used in the failing specimens and the quantities used in Trial 1 (e.g., the calcium silicate-2% silanol-3% silica fume specimen). Thus, the second trial indicated that a combination of silica fume and silanol may be able to yield an integrally waterproof fiber cement composite material in substantially smaller concentrations.

### Trial 3

In a third trial, various sample specimens of fiber cement composite materials were produced and tested using the ASTM D4068 hydrostatic pressure test. The specimens tested in the third trial included perlite specimens produced using both silanol and silica fume. The specimens were formulated based on a baseline formulation including cement comprising 30.20% of dry weight, silica comprising 53.90% of dry weight, cellulose fiber comprising 7.00% of dry weight, alumina comprising 3.00% of dry weight, and perlite comprising 5.90% of dry weight. The test specimens were formulated based on the above baseline formulation, by adding replacing the cement with silica fume in quantities of 0.5%, 2%, and 4%. For each of these three quantities of silica fume, three different formulations were produced by mixing the cellulose fiber with a silanol-dispersant solution in quantities of 0.5%, 1.5%, and 3% of fiber dry weight, respectively, before adding the remaining components. Thus, a total of nine different combination formulations were produced for the third trial. After mixing, each specimen formulation was cured in an autoclave. The silica fume was prepared by the same method as in Trial 2. The silanol-dispersant solution was prepared by the same method as in Trial 1.

Each formulation above was subjected to a 48-hour ASTM D4068 test. The results of the ASTM D4068 test are shown in Table 4 below.

TABLE 4
Results of ASTM D4068 testing of example fiber cement specimens

| Formulation | Result |
|---|---|
| Perlite Control | Fail |
| Perlite-0.5% silanol-0.5% silica fume | Pass |
| Perlite-1.5% silanol-0.5% silica fume | Pass |
| Perlite-3% silanol-0.5% silica fume | Pass |
| Perlite-0.5% silanol-2% silica fume | Pass |
| Perlite-1.5% silanol-2% silica fume | Pass |
| Perlite-3% silanol-2% silica fume | Pass |
| Perlite-0.5% silanol-4% silica fume | Pass |
| Perlite-1.5% silanol-4% silica fume | Pass |
| Perlite-3% silanol-4% silica fume | Pass |

Following the ASTM D4068 test, the specimens were further tested with a moisture meter to determine surface wetness. For each formulation, electrical conductivity (proportional to surface wetness) was measured for the surface opposite the column of water used for the ASTM D4068 test. The conductivity values were measured in a dimensionless scale corresponding to the moisture meter, and consistent across all samples. It was determined empirically that a conductivity value less than approximately 85 corresponds to a specimen passing the ASTM D4068 test (e.g., no droplet formation). Consistent with the results in Table 4 above, most of the specimens including both silica fume and silanol had a conductivity value significantly lower than 85, compared with the perlite control value greater than 85.

As shown in Table 4 above the specimens including both silica fume and silanol generally passed the ASTM D4068 test for waterproofness. Notably, the quantities of silica fume and silanol-dispersant solution used in producing some of the passing specimens was substantially lower than the quantities used in the failing specimens and the quantities used in Trials 1 and 2. For example, an integrally waterproof fiber cement composite material can be produced by replacing cement with silica fume at only 0.5% of dry weight, and mixing silanol-dispersant solution with the cellulose fiber at only 0.5% of total fiber dry weight. It is understood that these concentrations are low enough that they are unlikely to cause any production difficulties. Thus, the third trial confirmed that a combination of silica fume and silanol can be used to produce an integrally waterproof fiber cement composite material in commercially feasible concentrations.

### Trial 4

A fourth trial was conducted similar to Trials 1-3. In the fourth trial, a calcium silicate-0.5% silanol-0.5% silica fume specimen was tested to determine whether the 0.5%/0.5% combination yielded similar waterproofness in a formulation including calcium silicate rather than perlite. The calcium silicate-0.5% silanol-0.5% silica fume specimen included (dry weight) 28.2% cement, 55.8% silica, 7.0% cellulose fiber, 3.0% alumina, 5.5% calcium silicate, and 0.5% silica fume. The cellulose fiber was mixed with the same silanol-dispersant solution of Trial 1, in a quantity of 0.5% fiber dry weight. The silica fume was prepared as in Trial 2, and the specimen was cured in the same manner. The calcium silicate-0.5% silanol-0.5% silica fume specimen did not show evidence of droplet formation after 48 hours and accordingly passed the ASTM D4068 test.

The fourth trial additionally include a process trial to assess the effects of several variations in the mixing process for a single formulation. Each of four process trial specimens had a formulation including (dry weight) 25.7% cement, 55.8% silica, 7.0% cellulose fiber, 3.0% alumina, 5.5% calcium silicate, and 3% silica fume. The cellulose fiber in each specimen was mixed with silanol in a quantity of 2% of total fiber dry weight. Thus, the formulations corresponded to a calcium silicate-2% silanol-3% silica fume formulation.

Two variables were tested among the four process trial specimens. A first variable was whether to pre-disperse the silanol prior to adding (e.g., mixing the cellulose fiber with a silanol-dispersant solution vs. mixing the cellulose fiber with a pure silanol solution). The second variable was whether to pre-mix the silanol with the cellulose fiber (e.g., mixing the silanol or silanol-dispersant solution with the cellulose fiber prior to adding the remaining components vs. mixing the silanol or silanol-dispersant solution with the cellulose fiber and the remaining components at the same time).

Four specimens were produced to test each possible combination of variables. All specimens passed the ASTM D4068 test for waterproofness, as shown in Table 5 below.

TABLE 5
Results of ASTM D4068 testing of example fiber cement specimens

| Process | Result |
|---|---|
| Pre-mix fiber with silanol-dispersant solution | Pass |
| Pre-mix fiber with pure silanol solution | Pass |
| No pre-mix, silanol-dispersant solution | Pass |
| No pre-mix, pure silanol solution | Pass |

Following the ASTM D4068 test, the process trial specimens were further tested with a moisture meter to determine surface wetness. For each formulation, electrical conductivity (proportional to surface wetness) was measured for the surface opposite the column of water used for the ASTM D4068 test. The conductivity values in a dimensionless scale corresponding to the moisture meter, and consistent across all samples. It was determined empirically that a conductivity value less than approximately 85 corresponds to a specimen passing the ASTM D4068 test (e.g., no droplet formation). Consistent with the results in Table 5 above, the pre-mixed specimens had a conductivity value significantly lower than 85. However, despite passing the ASTM D4068 test, the specimens that were not pre-mixed had conductivity values of approximately 85. Based on the surface wetness testing in Trial 4, it was determined that pre-mixing the silanol with the cellulose fiber prior to adding the remaining components improved water resistance. However, pre-dispersing the pure silanol solution with a dispersant appeared not to have a significant impact on water resistance.

### Example Building Systems

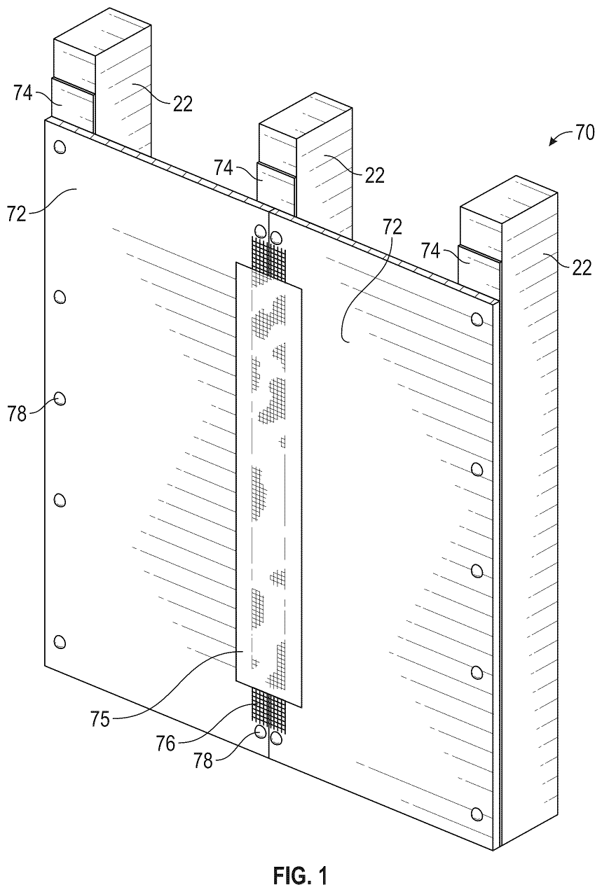

FIGS. 1-5 illustrate embodiments of building systems that can be used in conjunction with interior and/or exterior portions of a structure (for example, walls of a building). Each of the building systems 70, 80, 90, 1000, and 1100 discussed below and shown in FIGS. 1-5 are shown and described with reference to a vertically oriented framing members 22 (for example, wood studs). However, the building systems 70, 80, 90, 1000, and 1100 discussed below can be used in conjunction with various types of building substrates and/or structural frames. Further, one or more aspects or features of the building systems and components thereof discussed above (for example, building system 20) can be included in the building systems 70, 80, 90, 1000, and 1100 discussed below and/or shown in FIGS. 1-5. Likewise, one or more aspects or features of building systems 70, 80, 90, 1000, and 1100 can be included in the building systems discussed previously (for example, building system 20).

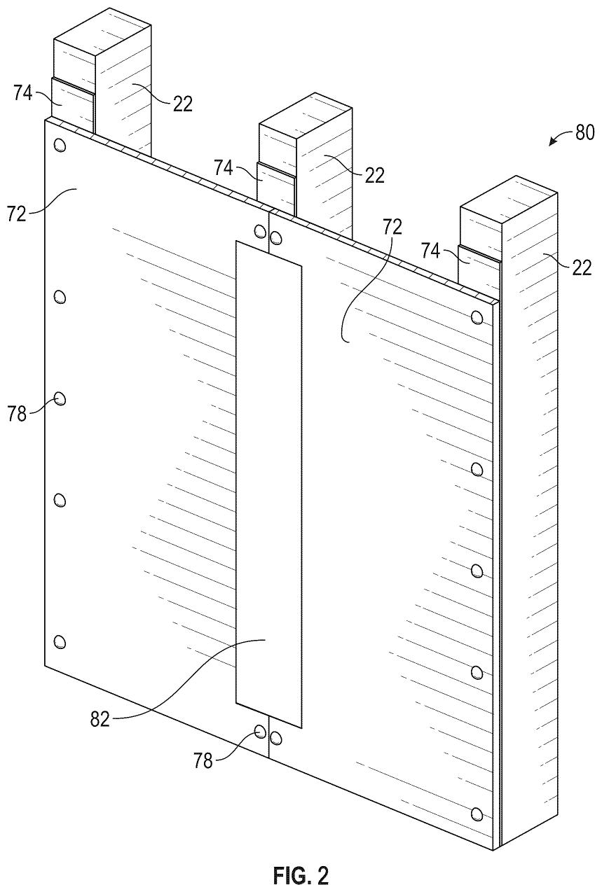

FIGS. 1-2 illustrate embodiments of a building system 70, 80. As shown, the building system 70, 80 can include building article(s) 72 which can be secured to framing members 22. For example, building article(s) 72 can be mechanically secured (e.g., with fasteners such as nails or screws) and/or chemically secured to framing members 22. FIGS. 1-2 illustrate two building articles 72 secured to framing members 22 with sides abutting one another and secured via fasteners 78 to a common framing member 22. As shown, such abutting sides of the building articles 72 can abut one another along an abutment line (also referred to as an “abutment joint”). While FIGS. 1-2 illustrate two abutting building articles 72, building system 70, 80 can include more than two building articles 72 and/or more than one pair of building articles 72 that abut each other (for example, at a common framing member 22) and secure to one or more framing members 22.

Building article 72 can be a cementitious building article. Building article 72 can be a fiber cement building article and can comprise cellulose and/or synthetic fibers (for example, polypropylene fibers), hydraulic binders, silica and water. Optionally, building article 72 can further comprise other additives, for example density modifiers. In one embodiment, building article 72 comprises a fiber cement panel having a front face and a rear face and an edge member intermediate to and contiguous to the front face and the rear face wherein the distance between the front face and the rear face comprises at least 0.8mm+0.5 mm. In one embodiment, building article 72 is formed by thin overlaying substrate layers using the Hatschek process.

In some embodiments, building article(s) 72 can comprise a composition such as, by way of non-limiting example, any of the compositions described herein in the Example Fiber Cement Composite Material Compositions and/or Composition and Manufacturing of Counterfeit Detection Features portions of the present disclosure.

FIGS. 1 and 2 illustrate various ways of providing weather or water resistance (for example, waterproofing) for building systems 70, 80 or portions thereof. A water resistant layer, barrier, or house wrap can be secured (for example, adhered and/or mechanically secured) along and/or in between framing members 22 (or portions thereof). As an example, a water resistant barrier or house wrap can be placed and/or secured on framing member 22 adjacent to (for example, behind and/or in front of) the point, region, and/or line (for example, abutment line) where edges or sides of two building articles 72 meet. For example, as shown in FIGS. 1 and 2, a water resistant layer 74 can be secured along a surface of framing member 22 adjacent to a location where portions of building articles 72 are to be secured side-by-side. For example, water resistant layer 74 can be positioned between framing member 22 and a rear face of building article 72. Such water resistant layer 74 can be any tape, membrane, or polymer that can provide weather and/or water resistance. In one embodiment, the water resistant layer 74 is butyl tape. Providing such water resistant layer 74 adjacent to (e.g., “behind”) and/or along the abutment line where sides of two adjacent building articles 72 meet and/or behind fastener holes can advantageously provide water resistance to the framing members 22 and/or interior portions of the wall including the framing members 22 (or interior portions of a building contained therein). Such water resistance is especially helpful where liquids penetrate through small gaps and space between the sides of two adjacent buildings articles 72 and/or through holes where fasteners 78 extend through the building article 72.

FIG. 1 further illustrates an optional weather resistant layer 75 secured (for example, adhered) along portions of the abutting sides of building articles 72 where edges (also referred to herein as “sides”) of the two building articles 72 meet. In such configuration, weather resistant layer 75 (also referred to herein as “water resistant layer”) can provide waterproofing benefits in addition or as an alternative to the water resistant layer 74. In some embodiments, building system 70 includes both layers 74 and 75, and water resistant layers 74, 75 can together sandwich portions of the abutting buildings articles 72 where the two articles 72 meet. Water resistant layer 75 can be a cementitious material and/or coating. For example, water resistant layer 75 can be thinset mortar. As shown in FIG. 1, building system 70 can include a mesh layer 76 (also referred to herein as “mesh”) that can be positioned between the water resistant layer 75 and the building articles 72 over the line where two sides of the articles 72. The mesh layer 76 can be a wire mesh and can be adhered (for example, glued) to surfaces of the building articles 72. The mesh layer 76 can help the water resistant layer 75 secure (for example, bond) to the surfaces of the building articles 72. As shown in FIG. 1, in some cases, the water resistant layer 75 and/or the mesh layer 76 can be placed adjacent and/or overtop (for example, covering) fasteners 78 which can fasten the building articles 72 to the framing members 22.

FIG. 2 further illustrates a building system 80 including an optional weather resistant layer 82 secured (for example, adhered) along portions of the abutting sides of building articles 72 covering the abutment line where the two articles 72 meet. In such configuration, weather resistant layer 82 (also referred to herein as “water resistant layer”) can provide waterproofing benefits in addition or as an alternative to the water resistant layer 74. In some embodiments, building system 80 includes both water resistant layer 74 and 82, and layers 74, 82 can together sandwich portions of the abutting buildings articles 72 where the two articles 72 meet. Water resistant layer 75 can be any tape, membrane, or polymer that can provide water resistance. As shown in FIG. 2, in some cases, the water resistant layer 82 can be placed adjacent and/or overtop (for example, covering) fasteners 78 which can fasten the building articles 72 to the framing members 22.

While FIGS. 1-2 illustrate building systems 70, 80 having three framing members 22, two building articles 72, it is to be understood that building systems 70, 80 are not limited to these illustrated configurations. Building systems 70, 80 can include a multiple pairs of building articles 72 secured to a plurality of framing members 22, and such building articles 72 can be secured to the framing members 22 via vertical stacking and/or horizontal abutting. Additionally, building systems 70, 80 can include framing members in addition to framing members 22 which are shown as vertical studs. For example, building systems 70, 80 can include horizontal framing members which are disposed between the vertical framing members 22. In such configuration portions of the building articles 72 can be secured to such additional framing members.

In some embodiments, building articles 72 can act as sheathing when secured to framing members 22, and can provide resistance against shear forces experienced by the building system 70, 80. In some embodiments, building system 70, 80 includes building articles 72 but does not include wood sheathing (for example, oriented strand board). In alternative embodiments, wood sheathing can be included as an alternative to building articles 72. In some embodiments, building system 70, 80 includes wood sheathing secured to framing members 22 (with or without the water resistant layer 74) and building articles 72 are secured overtop and/or adjacent to such sheathing. In such embodiments where building system 70, 80 includes both wood sheathing secured to framing members 22 and building articles 72, building system 70, 80 can additionally include furring strips in the form of battens positioned between the wood sheathing and the building articles 72. In some embodiments, building system 70, 80 includes one or more panels which can be secured to the front faces of the building articles 72, for example, fiber cement wall panels. In such embodiments, building system 70, 80 can additionally include furring strips in the form of battens positioned between the building articles 72 and such fiber cement wall panels.

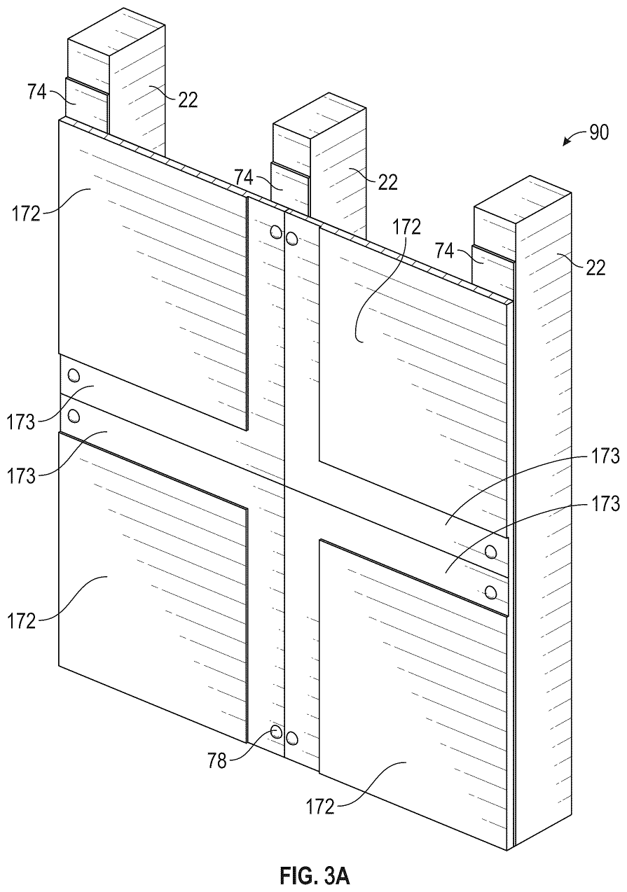

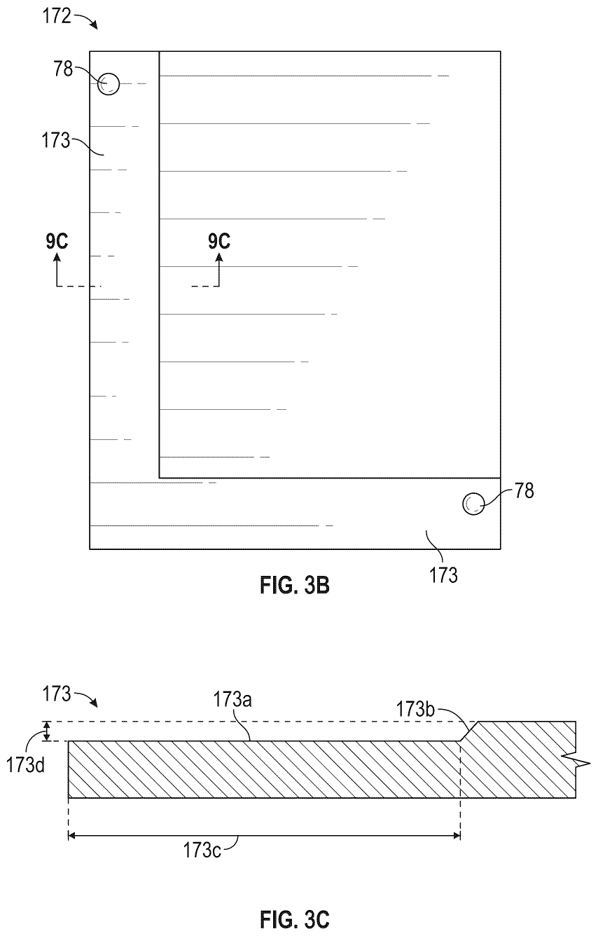

FIG. 3A illustrates an embodiment of a building system 90 that can be similar to building systems 70, 80 in many respects. Building system 90 can include framing members 22, water resistant layer 74, building articles 172, and fasteners 78 (for example, a nail) which can help secure the building articles 172 and/or water resistant layer 74 to the framing members 22. Building article 172 can be the same as building articles 72 in some or many respects. For example, building article 172 can be a cementitious building article. Building article 172 can be a fiber cement building article and can comprise cellulose and/or synthetic fibers (for example, polypropylene fibers), hydraulic binders, silica and water. Optionally, building article 172 can further comprise other additives, for example density modifiers. In one embodiment, building article 172 comprises a fiber cement panel having a front face and a rear face and an edge member intermediate to and contiguous to the front face and the rear face wherein the distance between the front face and the rear face comprises at least 0.8 mm+0.5 mm. In one embodiment, building article 172 is formed by thin overlaying substrate layers using the Hatschek process. As described with reference to building article 72, in some embodiments, building article(s) 172 can comprise a composition such as, by way of non-limiting example, any of the compositions described herein in the Example Fiber Cement Composite Material Compositions and/or Composition and Manufacturing of Counterfeit Detection Features portions of the present disclosure.

Building articles 172 can include recessed portions 173 extending along portions of the building articles 172. For example, as shown in FIG. 3A, building articles 172 can include recessed portion(s) 173 that extend along a surface of the articles 172 adjacent and/or proximate the edges or sides of the building articles 172. Such recessed portion(s) 173 can extend along a surface of the building article 172 adjacent and/or proximate one, two, three, or four edges or sides of building article 172. Recessed portions 173 can advantageously accommodate a thickness of a weather resistant layer 82, 75 and/or mesh layer 76, and/or head of fastener(s) 78 so that, when such layers 82, 75, 76 are secured over the line where two abutting building articles 72 meet, a surface of such layers 82, 75, 76 is planar (for example, “flush”) with a surface of the building articles 172. For example, recessed portions 173 can be sized, shaped, and/or otherwise configured to accommodate a thickness, width, and/or length of layers 82, 75, and/or 76 so that the surfaces of the layers 82, 75, and/or 76 are flush with the surfaces (for example, surrounding surfaces) of the building articles 172. While FIG. 3A illustrates four, abutting building articles 172, each having two recessed portions 173 extending along sides thereof, building articles 172 can include more or less recessed portions 173 depending on the configuration and/or amount of building articles 172 in building system 90. For example, where additional building articles are secured to framing members 22 above and/or to the sides of the two, rightmost building articles 172 in FIG. 3A, the top, rightmost building article 172 could have recessed portions 173 extending along the top and right edges or sides in addition to the recessed portions 173 extending along the left and bottom edges or sides. As shown in FIG. 3A, the recessed portions 173 can have a width such that one or more fasteners 78 can be positioned therewithin when fixed to the building articles 172, framing members 22 and/or water resistant layer 74. In some embodiments, building system 90 includes weather resistant layer 82, 75 (with or without mesh layer 76) along one or more of the recessed portions 173 in order to provide waterproofing of along the abutment line of two adjacent building articles 172. In some embodiments, building system 90 does not include any fasteners 78 within the recessed portions 173, but only in the non-recessed portions of building articles 172.

FIG. 3B illustrates an enlarged front view of the top, rightmost building article 172 of FIG. 3A, while FIG. 3C illustrates a cross-section through a recessed portion 173 of such building article 172. As shown, recessed portion 173 can include a depth 173d and a width 173c extending from an edge or side of building article 172. While surface 173a of recessed portion 173 is shown as flat, in some embodiments, surface 173 is angled and/or tapered to or from the edge or side of building article 172. Surface 173a can join a front (e.g., top) surface of building article 172 at a transition region 173b, which can be transverse (for example, perpendicular) to a plane of the front or top surface of building article 172 and/or to surface 173a. In some embodiments, transition region 173b is angled with respect to surface 173c and/or a front or top surface of building article 172 at an angle of 5°, 10°, 15°, 20°, 25°, 30°, 35°, 40°, 45°, 50°, 55°, 60°, 65°, 70°, 75°, 80°, 85°, or 90°, or any value therebetween, or any range bounded by any combination of these values, although values outside these values or ranges can be used in some cases. In some embodiments, recessed portion 173 does not include a transition region 173b, but rather, comprises a tapered surface 173a which tapers from a maximum depth gradually upward a certain distance (e.g., width 173c) until the depth is zero and the full thickness of the article 172 is reached.

As discussed above, recessed portions 173 can advantageously accommodate a thickness of a weather resistant layer 82, 75, and/or mesh layer 76 so that, when such layers 82, 75, 76 are secured over the abutment line where two adjacent building articles meet 172, a surface of such layers 82, 75, 76 is planar (for example, “flush”) with a surface of the building articles 172. With reference to FIG. 3C, recessed portion 173 can have a depth 173d that is greater than or equal to a thickness of weather resistant layer 82, or weather resistant layer 75 and/or mesh layer 76. Recessed portion 173 can have a depth 173d that is within a certain percentage (e.g., greater than or less than) of the thickness of weather resistant layer 82, or weather resistant layer 75 and/or mesh layer 76. For example, recessed portion 173 can have a depth 173d that is within 1%, 2%, 3%, 4%, 5%, 6%, 7%, 8%, 9%, 10%, 15%, or 20% of the thickness of weather resistant layer 82, or weather resistant layer 75 and/or mesh layer 76, or any percentage value between the above-listed percentage values, or any range bounded by any combination of these percentage values, although percentage values outside these values or ranges can be used in some cases. As another example, recessed portion 173 can have a depth 173d that is 0.25 mm, 0.5 mm, 0.75 mm, 1 mm, 2 mm, 3 mm, 4 mm, 5 mm, 6 mm, 7 mm, 8 mm, 9 mm, 10 mm, 15 mm, 20 mm, 25 mm, 30 mm, 35 mm, 40 mm, 45 mm, or 50 mm, or any value therebetween, or any range bounded by any combination of these values, although values outside these values or ranges can be used in some cases. Additionally or alternatively, depth 173d can be less than a certain percentage of a thickness of building article 172 so as not to affect the structural integrity of the article 172. For example, depth 173d can be less than 1%, 2%, 3%, 4%, 5%, 6%, 7%, 8%, 9%, 10%, 15%, 20%, 25%, or 30% of the thickness of building article 172, or any value therebetween, or any range bounded by any combination of these values, although values outside these values or ranges can be used in some cases.

Recessed portion 173 can have a width 173c that is greater than or equal to a width of weather resistant layer 82, or weather resistant layer 75 and/or mesh layer 76. Recessed portion 173 can have a width 173c that is greater than the width of the weather resistant layer 82, or weather resistant layer 75 and/or mesh layer 76 by a certain percentage. For example, recessed portion 173 can have a width 173c that is greater than the width of the weather resistant layer 82, or weather resistant layer 75 and/or mesh layer 76 by 1%, 2%, 3%, 4%, 5%, 6%, 7%, 8%, 9%, 10%, 15%, or 20%, or any percentage value between the above-listed percentage values, or any range bounded by any combination of these percentage values, although percentage values outside these values or ranges can be used in some cases. Recessed portion 173 can have a width 173c that is a certain percentage of the width and/or length of building article 172. For example, recessed portion 173 can have a width 173c that is 1%, 5%, 10%, 15%, 20%, or 25% of the width and/or length of building article 172, or any percentage value therebetween, or any range bounded by any combination of these percentage values, although percentage values outside these values or ranges can be used in some cases. Recessed portion 173 can have a width 173c that is ¼ inch (0.635 cm), 1/2 inch (1.27 cm), 1 inch (2.54 cm), 1.5 inch (3.81 cm), 2 inch (5.08 cm), 2.5 inch (6.35 cm), 3 inch (7.62 cm), 4 inch (10.2 cm), 5 inch (12.7 cm), 6 inch (15.2 cm), 7 inch (17.8 cm), 8 inch (20.3 cm), 9 inch (22.9 cm), or 10 inch (25.4 cm) depending on the width and/or length of the building article 172. Width 173c can be any value in between these values, or any range bounded by any combination of these values, although values outside these values or ranges can be used in some cases.

Any of the building systems 70, 80, 90 can be utilized for exterior or interior implementations for example, where building systems 70, 80, 90 are used for interior applications within a building, the building articles 72, 172, can be coated and/or covered with a coating, finish, and/or tile (such as a vinyl stone).

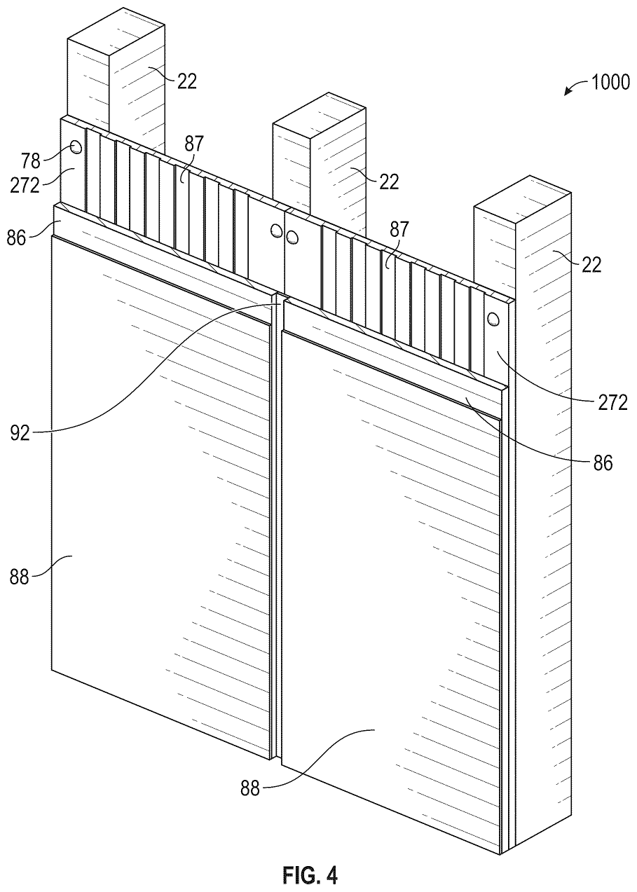

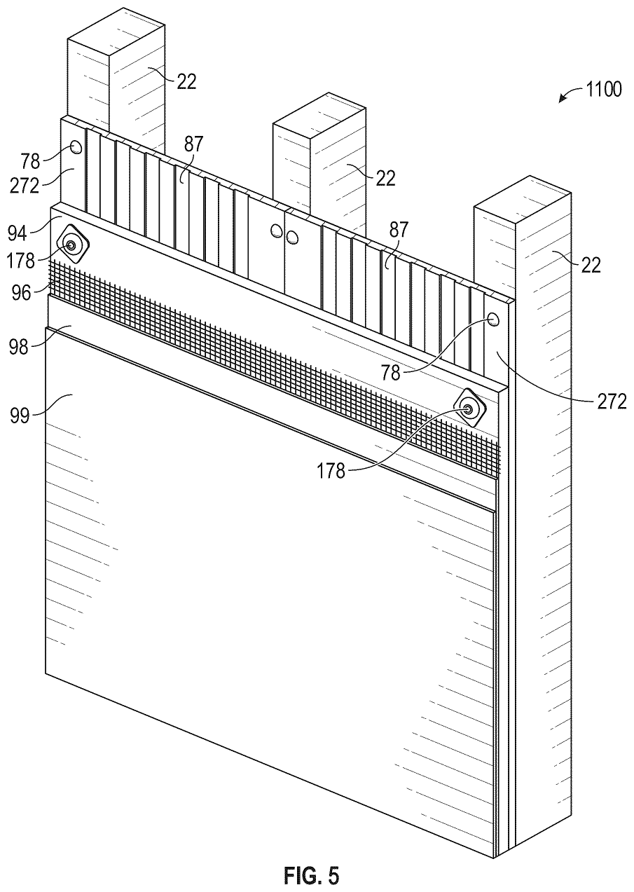

FIGS. 4-5 illustrate embodiments of a building system 1000, 1100 that can be similar to building systems 70, 80, 90 in many respects. Building system 1000, 1100 can include framing members 22, building articles 272, and fasteners 78 (for example, a nails) which can help secure the building articles 272 to the framing members 22. While not shown, building system 1000, 1100 can include water resistant layer 74 between framing members 22 and building articles 272 along and/or near where the two building articles 272 meet, similar or identical as that discussed above with reference to FIGS. 1-3C.

Building article 272 can be the same as building article 72, 172 in some or many respects. Building article 272 be a cementitious building article. Building article 272 can be a fiber cement building article and can comprise cellulose and/or synthetic fibers (for example, polypropylene fibers), hydraulic binders, silica and water. Optionally, building article 272 can further comprise other additives, for example density modifiers. In one embodiment, building article 272 comprises a fiber cement panel having a front face and a rear face and an edge member intermediate to and contiguous to the front face and the rear face wherein the distance between the front face and the rear face comprises at least 0.8 mm±0.5 mm. In one embodiment, building article 272 is formed by thin overlaying substrate layers using the Hatschek process. As described with reference to building article 72, 172, in some embodiments, building article 272 can comprise any known fiber cement composition such as, by way of non-limiting example, any of the compositions described herein in the Example Fiber Cement Composite Material Compositions and/or Composition and Manufacturing of Counterfeit Detection Features portions of the present disclosure.

As shown in FIG. 4, building articles 272 can include a plurality of drainage channels 87. As shown in FIGS. 4-5, drainage channels 87 can be located on a front face of building article 272. Such front face can be opposite to a rear face that contacts the framing members 22 in FIGS. 4-5. Thus, such drainage channels 87 can be positioned on a surface of the building article 272 that faces away from the structural framing and/or interior of a building when the building article 272 is secured thereto. In some embodiments, drainage channels 272 are integrally formed with building article 272. As discussed above with reference to other drainage channels disclosed herein, drainage channels 87 can advantageously form a capillary break and air gap to facilitate drainage, ventilation, and/or moisture management between the building article 272 and a weather resistant layer or barrier (such as weather resistant layer 74) and/or a structural frame (including, for example, framing members 22). As also discussed, such drainage channels 87 can eliminate the need for furring strips.

In some embodiments, one or more faces of building article 272 can include a coating agent. For example, one or more of the drainage channels 87 can be coated with a coating agent to further assist drainage action and the capillary break functionality of each drainage channel 87. For example, a coating agent may provide a smoother surface than an uncoated building article 272 (such as a cementitious building article), so as to further facilitate the flow of water or any other liquid along the surface of the building article 272. Enhanced flow of water along the surface of the building article 272 can further enhance the drainage efficiency of the building article 272. In some embodiments, drainage channels 87 have a funnelled configuration wherein one or more of the drainage channels 87 are slightly widened at one or both ends of the drainage channel 87.

FIG. 4 illustrates an embodiment of building system 1000 which includes a panel 86 and a coating 88. Panel 86 can comprise a cementitious material. For example, panel 86 can be a fiber cement panel comprising a fiber cement composition. Coating 88 can be a paint, render finish, or other coating or material adhered to a front face of panel 86. As shown in FIG. 4, panels 86 can be placed adjacent and/or in front of building articles 272 and can be secured to building articles 272 and framing members 22. Such securement can be by, for example, mechanicals fasteners. As also shown in FIG. 4, sides of two adjacent panels 86 can be separated by an express joint 92 which can include a metal strip, for example.

FIG. 5 illustrates an embodiment of building system 1100 which includes an insulation panel 94, mesh layer 96, and one or more coating layers 98, 99. Building system 1100 can have one or both of coating layers 98, 99. The one or more coating layers 98, 99 can comprise, for example, a cementitious and/or polymeric coating and/or an acrylic (for example, acrylic paint). For example, coating layer 98 can be a basecoat, and/or coating layer 99 can be a topcoat. The basecoat and/or topcoat can comprise, for example, acrylic (such as acrylic paint). The one or more coating layers 98, 99 can be an exterior finish comprising, for example, plaster or stucco. The mesh layer 96 can comprise a wire or fiberglass reinforcing mesh, for example. As shown, the insulation panel 94 can be secured to the building articles 272 and the framing members 22 via fasteners 178 which may be mounted along with a washer or other piece to aid securement. Additionally, the mesh layer 96 can be secured (for example, adhered) to the insulation panel 94, and the basecoat 98 and/or topcoat 99 can be secured (for example, adhered) to the mesh layer 96 and/or the insulation panel 94 as shown.

While FIGS. 1-5 illustrate various features, aspects, and/or configurations for building systems 70, 80, 90, 1000, 1100, the features, aspects, and/or configurations shown in any of these systems 70, 80, 90, 1000, 1100 can be combined and/or incorporated into any other of the systems 70, 80, 90, 1000, 1100, and vice versa. As an example, any of the building articles 72, 272 can include the recessed portions 173 discussed and shown with reference to FIG. 3A-3C and building article 172. As another example, any of the building articles 72, 172 can include the drainage channels 87 discussed and shown with reference to FIG. 4-5 and building article 272. As another example, any of the building systems 70, 80, 90 could include one or more of panel 86, coating 88, insulation panel 94, basecoat 98, and/or topcoat 99 secured adjacent to the building article 72, 172, weather resistant layer 75, mesh layer 76, and/or weather resistant layer 82. As another example, any of the building systems 1000, 1100 can include the water resistant layer 74 positioned between building articles 272 and framing members 22.

Fiber Cement Materials with Counterfeit Detection Features

Disclosed herein are fiber cement composite articles including defensive measures against the unauthorized sale of counterfeit articles. Defensive measures include one or more pigmented layers disposed between adjacent laminated layers within a fiber cement article. The pigmented layers can have a color different and visually distinguishable relative to the color of the adjacent laminated layers. In some embodiments, a fiber cement article such as a board, panel, sheet, or the like, can include several parallel pigmented layers. For example, a pigmented layer may be provided between each pair of adjacent laminated layers of the fiber cement article, such that the pigmented layers are regularly spaced and readily visible to an observer. Advantageously, the pigmented layers disclosed herein may be included in a fiber cement article without negatively affecting the strength or integrity of the finished article.

The manufacturing processes disclosed herein utilize pigments having suitably small particles sizes so as to provide for a thin and consistent pigmented layer covering substantially the full length and width of an article such that any portion of an article may be tested to confirm authenticity. Moreover, the particular processes and pigment particle sizes disclosed herein result in pigmented layers that remain visibly defined rather than smearing or bleeding when the articles are saw cut to confirm authenticity, as smearing or bleeding of the layers would complicate attempts to visibly confirm the presence of the pigmented layers.

As will be described in greater detail, the pigmented layers disclosed herein, when incorporated into manufactured fiber cement articles, may allow for purchasers or installers of fiber cement products to easily ascertain that a batch of fiber cement articles are genuine and not counterfeit prior to installation. For example, an installer may obtain a batch of fiber cement articles for installation. After obtaining the articles, such as at the installation site prior to installation, the installer may select one sample article from the batch and use a saw to cut off a portion of the sample article. The installer may then visually inspect the freshly cut faces of the sample article to see whether the pigmented layers can be observed within the fiber cement material. If the pigmented layers are observed, the installer may proceed with the installation having confirmed that the articles are genuine and are likely to perform as expected. If no pigmented layers are observed, the installer may test one or more additional sample articles from the batch, and/or may contact the seller and/or the purported manufacturer to report the possible counterfeit goods.

### Composition and Manufacturing of Counterfeit Detection Features

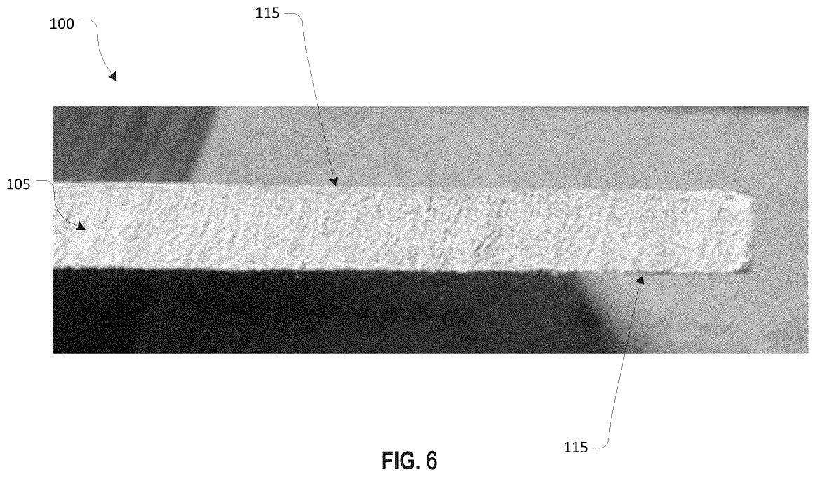

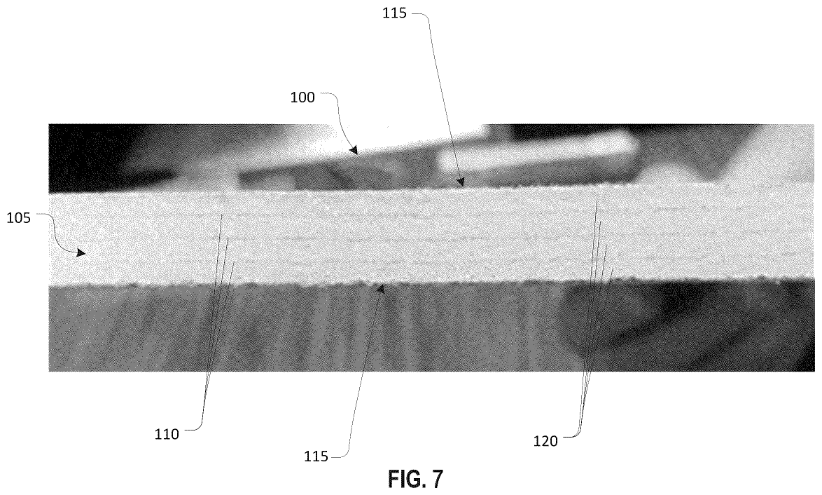

FIGS. 6 and 7 are side sectional views of an example fiber cement article 100 including pigmented layers 110 that provide for counterfeit detection. FIG. 6 is a side view illustrating a side surface 105 of an article 100 that has been cut substantially perpendicular to its major faces 115 by a water jet or similar relatively coarse cutting method. FIG. 7 is a side view illustrating the side surface 105 of the article 100 having been cut using a saw or similar relatively smooth cutting method. It will be appreciated that the pigmented layers 110 that are visible on the side surface 105 in FIG. 7 are not visible in FIG. 6. Thus, as illustrated in FIGS. 6 and 7, a fiber cement article may be produced with included pigmented layers, and may be finished by water jet or similar coarse cutting method, and/or covered in a paint and/or primer, such that the pigmented layers are not visible on the finished article unless the article is cut by a saw or similar relatively smooth cutting method.

A finished article, such as the article 100 of FIG. 7, may include a plurality of laminated layers 120 of fiber cement material integrally formed or adhered together to form the article 100. Each pigmented layer 110 may be a layer of material including particles of one or more pigments having a different color relative to the color of the neighboring laminated layers 120 of fiber cement. In some embodiments, the pigmented layers in an article may be the same color, or may be different colors, for example, so as to form a predetermined sequence of colors indicative of authenticity (e.g., an article may be formed with two green pigmented layers and one red pigmented layer such that other colors or combinations of colors may be indicative of a counterfeit article). In some embodiments, the pigments included within the pigmented layers may be inorganic pigments. Any suitable inorganic pigment may be used. For example, in some embodiments the pigment or pigments include metal oxides such as titanium oxides (e.g., TiO, TiO₂, etc.), iron oxides (e.g., FeO, FeO₂, Fe₂O₃, Fe₃O₄, etc.), silicon oxides (e.g., SiO₂), aluminum oxides (e.g., Al₂O₃, etc.), or the like.

The pigmented layers described herein may be created so as to avoid inhibiting interlaminate bonding between adjacent laminated fiber cement layers, and may in some embodiments promote interlaminate bonding. The pigment particles within the pigmented layers may be suspended within a material adhering the adjacent laminated layers of fiber cement, or may be contained with adjacent portions of the adjacent laminated layers themselves. The pigment particles preferably have a relatively small particle size so as to prevent causing delamination or otherwise interfering with the adherence between the adjacent laminated layers of fiber cement. For example, in some embodiments the pigment particles have an average particle size of less than 50 micron, less than 20 micron, etc. In some embodiments, the pigment particles have a particle size of between 1 micron and 20 micron, between 2 micron and 10 micron, etc. In some embodiments, the pigment particles have a size of approximately 5 micron, such as between about 2.5 micron and about 7.5 micron.

Testing performed on example fiber cement articles, including the pigmented layers disclosed herein, indicated that a suitably small particle size may be critical to acceptable performance. For example, pigment particles having sizes of about 50 micron or smaller provided a relatively thin pigmented layer having a consistent thickness across the full extent of the article. However, pigmented layers produced with larger pigment particles were found to have uneven thicknesses in different regions of the same article and may even detrimentally affect the structural integrity of the article. In addition, larger pigment particles resulted in layers that were prone to smearing or bleeding at the location of a saw cut, obscuring the pigmented stripes intended to be visible at the side surface of a cut article when visually inspecting the cut article to confirm authenticity. In contrast, articles produced with smaller pigment particles as described herein, when saw-cut for inspection, yielded consistently contrasting and sharply defined stripes at the sawn side surfaces.

The pigment particles may be applied within a liquid carrier, which may be dried or otherwise removed during the curing process of the fiber cement articles. The liquid carrier may be, for example, water or any other suitable solvent or suspension medium. In one example, the pigment may be applied in an aqueous suspension including between 1 wt % and 10 wt %, such as approximately 2.5 wt %, of pigment. Other components may be included in the suspension or solution to enhance adhesion between adjacent laminate layers of fiber cement. The pigment solids may be treated with a high-shear dispersion process prior to application to ensure consistent color and thickness of the pigmented layers. The amount of pigment and carrier deposited may be metered so as to produce a desired thickness within the layer. For example, the suspension or solution may be applied at a dose of, for example, 6 to 9 dry grams per square foot of the fiber cement layer.

A fiber cement article may be produced by various manufacturing processes that produce layers of fiber cement material. In some examples, a fiber cement article may be produced by the Hatschek process. In the Hatschek process, a fiber cement slurry is formed, which may comprise a hydraulic binder, aggregates, water, and cellulose and/or polypropylene fibers. The slurry is deposited on a plurality of sieve cylinders that are rotated through the fiber cement slurry such that the fibers filter the fiber cement slurry to form a thin fiber cement film on a belt passing in contact with the sieve cylinders. A region of the belt containing a layer of fiber cement film may be passed over the sieve cylinders again to form an additional layer of fiber cement film against the first layer, and the process may be repeated until enough layers of fiber cement film are present to form an article having a desired thickness. For example, in some embodiments the article may be formed with two, three, four, five, or more layers. In the example article of FIG. 7, a total of four laminated layers of fiber cement are included. When all desired laminated layers are formed, water is removed and the layered article can be cured, such as in an autoclave, to produce a dry finished fiber cement article.

In the Hatschek process described above, the counterfeit detection features disclosed herein may be added by applying a layer of a pigment suspension, such as any of the pigment suspensions described herein, over one or more layers, or each layer of the fiber cement, after the layer is formed and before the next layer is formed in a subsequent pass over the sieve cylinders. For example, the pigment suspension may be applied by spraying or dripping the pigment suspension onto the formed layer, passing the formed layer through a container of the pigment suspension, passing the formed layer under a slot die applying the pigment suspension, or any other suitable means of applying the pigment suspension to the surface of the fiber cement. It may be preferable to apply the pigment suspension by a method that provides a thin and even coat over substantially the entire surface of each fiber cement layer such that, after curing, the pigmented layers are present throughout the full area of the finished fiber cement article, and any portion of the article may be tested to confirm authenticity.

### Example Fiber Cement Composite Material Compositions

As described above, the counterfeit detection features disclosed herein may be implemented in conjunction with any fiber cement formulation that can be used to form an article including two or more layers. Various example fiber cement composite material formulations compatible with the disclosed counterfeit detection features will now be described. It will be understood that the following example formulations are merely examples of the formulations that may be used, and that the scope of the present disclosure is not limited to the following formulations.

Embodiments of fiber cement composite material compositions generally include a cementitious hydraulic binder, such as Portland cement or any other suitable cement, silica, and fibers, such as cellulose or other suitable fibers. The fiber may include a blend of two or more types of fibers, and may include recycled fiber materials. In some embodiments, the fiber is added in the form of a pulp, such as wood pulp or the like. The fiber cement composite materials may further include additional components such as silica, alumina, coloring additives, or the like. One or more density modifiers, such as low density additives, may further be included. Coloring additives may include, for example, pigments such as red or pink clay, or the like. Density modifiers may include, for example, low-density additives such as calcium silicate, perlite, or the like. The components of a fiber cement composite material formulation may be mixed in a slurry form including water, and may be formed into fiber cement composite materials by any of various processes such as a Hatschek process or the like. Water content may be removed from the fiber cement composite materials by various curing methods including autoclaving or the like, to form solid fiber cement composite materials.

In example fiber cement formulations including coloring additives, the pigment in the pigmented layers between the laminated fiber cement layers may be selected to be a contrasting color relative to the colored fiber cement material. For example, fiber cement composite material including red or pink clay as a coloring additive may be manufactured with black or green pigmented layers to provide counterfeit detection, as red or pink pigmented layers may be difficult to identify visual due to their similarity or lightness relative to the color of the laminated fiber cement layers that form the majority of the thickness of the article.

In various formulations, the cement may comprise between 20% and 45% of the dry weight of the slurry. For example, the cement may comprise between 25% and 39% of dry weight, between 25% and 29% of dry weight, between 35% and 39% of dry weight, or any percentage within the preceding ranges. Cement content less than 20% or greater than 45% is similarly possible. In some embodiments, a relatively lower cement content, such as between 25% and 29% of dry weight, may be desirable for interior cladding articles, interior board, or the like. In some embodiments, a relatively higher cement content, such as between 35% and 39% of dry weight, may be desirable for exterior cladding articles. In some embodiments, the fiber cement material may be a water resistant or waterproof fiber cement including silica fume. In such embodiments, it will be understood that each of the cement contents or cement content ranges disclosed herein may be reduced by an amount of silica fume added to the formulation. For example, a baseline cement content of between 25% and 39% of dry weight may correspond to an actual cement content of between 23% and 37% of dry weight if 2% by weight of silica fume is included in the formulation.

In various formulations, cellulose fibers may comprise between 3% and 15% of dry weight of the slurry. For example, the cellulose fibers may comprise between 5% and 10% of dry weight, between 6% and 9% of dry weight, between 6.5% and 7.5% of dry weight, between 7.75% and 8.75% of dry weight, or any percentage within the preceding ranges. Cellulose fiber content less than 3% or greater than 15% is similarly possible. In some embodiments, a relatively lower cellulose fiber content, such as between 6.5% and 7.5%, or approximately 7% of dry weight, may be desirable for interior cladding articles, interior board, or the like. In some embodiments, a relatively higher cellulose fiber content, such as between 7.75% and 8.75%, or approximately 8.25% of dry weight, may be desirable for exterior cladding articles.

In various formulations, the silica may comprise any percentage between 50% and 60% of dry weight. For example, the silica may comprise approximately 50% of dry weight, 54% of dry weight, 56% of dry weight, 58% of dry weight, etc. In various formulations, the alumina may comprise any percentage between 2% and 5% of dry weight. For example, the alumina may comprise approximately 3% of dry weight, approximately 3.5% of dry weight, etc. In various formulations, the density modifier may comprise any percentage between 0% and 7% of dry weight. For example, some formulations may include no density modifier, or may include approximately 2% of dry weight, approximately 3% of dry weight, approximately 4% of dry weight, approximately 5% of dry weight, approximately 5.5% of dry weight, approximately 7% of dry weight, etc. Common density modifiers present in these quantities may include calcium silicate, perlite, or the like.

In some embodiments, additional components may be included as components in a fiber cement composite material, in addition to the components described above. For example, in some embodiments a fiber cement composite material formulation may include one or more components that cause water resistance or waterproofness of the finished fiber cement composite material. One example component is a hydrophobic agent such as a silanol solution, which may include silanol and water or another suitable solvent. Without being bound by theory, it is understood that silanols increase water resistance because they act as hydrophobic agents making the surfaces of the fibers hydrophobic and, when used to treat fiber cement fibers, prevent water from traveling through the fiber cement matrix along the edges of the fibers. In some embodiments, a silanol solution may be mixed with the fiber component of the fiber cement formulation. The silanol solution may be added to the fibers at the time the fiber is mixed with the remaining components of the fiber cement formulation, or may be pre-mixed with the fiber (e.g., for 1 minutes, 5 minutes, 10 minutes, 20 minutes, or more) prior to adding the remaining components of the fiber cement formulation. Quantities of silanol solution to be added to the fibers may be determined such that the silanol have a dry weight of approximately 0.25% of fiber dry weight, approximately 0.5% of fiber dry weight, approximately 1% of fiber dry weight, approximately 2% of fiber dry weight, approximately 3% of fiber dry weight, approximately 4% of fiber dry weight, approximately 5% of fiber dry weight, or more. The dry weight of the silanol may be in any suitable range such as between 0.25% and 3% of fiber dry weight, between 0.25% and 2% of fiber dry weight, between 0.25% and 1% of fiber dry weight, or any sub-range therebetween.

Silica fume is another example component that may be included in some fiber cement composite material formulations. Silica fume is a fine pozzolanic material comprising amorphous silica. Silica fume may be produced, for example, as a byproduct of the production of elemental silicon or ferro-silicon alloys in electric arc furnaces. Silica fume may be included in a variety of concrete and cementitious products, but is not typically used for waterproofing implementations. However, it has been discovered that silica fume may enhance the water resistance of fiber cement composite materials and may yield integrally waterproof fiber cement composite materials when included in conjunction with silanol.

Without being bound by theory, it is believed that the relatively fine size of silica fume, relative to the other components of a fiber cement article, may reduce porosity of the cementitious matrix between fibers. Moreover, silica fume can conveniently be added to fiber cement formulations as a replacement for a portion of the cement. For example, in some embodiments the cement component of the fiber cement may be reduced by an equal weight to the weight of silica fume added to the formulation, without undesirably affecting other physical properties of the fiber cement articles such as dimensional stability, flexural strength, or the like. In various formulations, the amount of silica fume in a fiber cement article may be, for example, between 0.25% and 5% of dry weight, between 0.25% and 4% of dry weight, between 0.25% and 3% of dry weight, between 0.25% and 2% of dry weight, between 0.25% and 1% of dry weight, or any sub-range or percentage therebetween. For example, in some embodiments, the silica fume content is approximately 0.5% of dry weight, approximately 1% of dry weight, approximately 1.5% of dry weight, approximately 2% of dry weight, etc. However, relatively large quantities of silica fume (e.g., above 2-3% of dry weight) may interfere with commercial-scale production of fiber cement composite materials.

Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as any subcombination or variation of any subcombination.

Moreover, while methods may be depicted in the drawings or described in the specification in a particular order, such methods need not be performed in the particular order shown or in sequential order, and that all methods need not be performed, to achieve desirable results. Other methods that are not depicted or described can be incorporated in the example methods and processes. For example, one or more additional methods can be performed before, after, simultaneously, or between any of the described methods. Further, the methods may be rearranged or reordered in other implementations. Also, the separation of various system components in the implementations described above should not be understood as requiring such separation in all implementations, and it should be understood that the described components and systems can generally be integrated together in a single product or packaged into multiple products. Additionally, other implementations are within the scope of this disclosure.

Conditional language, such as “can,” “could,” “might,” or “may,” unless specifically stated otherwise, or otherwise understood within the context as used, is generally intended to convey that certain embodiments include or do not include, certain features, elements, and/or steps. Thus, such conditional language is not generally intended to imply that features, elements, and/or steps are in any way required for one or more embodiments.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Although making and using various embodiments are discussed in detail below, it should be appreciated that the description provides many inventive concepts that may be embodied in a wide variety of contexts. The specific aspects and embodiments discussed herein are merely illustrative of ways to make and use the systems and methods disclosed herein and do not limit the scope of the disclosure. The systems and methods described herein may be used for formulation of cementitious and/or fiber cement building articles and are described herein with reference to this application. However, it will be appreciated that the disclosure is not limited to this particular field of use.

1-29. (canceled)

30. A fiber cement article comprising:
a first major face;
a second major face opposite the first major face; and
an intermediate portion disposed between the first major face and the second major face, the intermediate portion comprising:
a plurality of laminated layers of fiber cement; and
one or more pigmented layers disposed between adjacent layers of the plurality of laminated layers, the one or more pigmented layers having a different color relative to the plurality of laminated layers.

31. The fiber cement article of claim 30, wherein the one or more pigmented layers comprise particles of a pigment having an average particle size smaller than approximately 50 micron.

32. The fiber cement article of claim 31, wherein the pigment has an average particle size of between approximately 1 micron and approximately 10 micron.

33. The fiber cement article of claim 32, wherein the pigment has an average particle size of between approximately 2.5 micron and approximately 7.5 micron.

34. The fiber cement article of claim 30, wherein the one or more pigmented layers comprise an inorganic pigment.

35. The fiber cement article of claim 34, wherein the inorganic pigment comprises at least one of an iron oxide, an aluminum oxide, a silicon oxide, or a titanium oxide.

36. The fiber cement article of claim 35, wherein the inorganic pigment comprises a red iron oxide.

37. The fiber cement article of claim 30, wherein the plurality of laminated layers of fiber cement each comprise a cementitious hydraulic binder, silica, cellulose fibers, and one or more additives.

30. The fiber cement article of claim 30, wherein the plurality of laminated layers of fiber cement are integrally waterproof fiber cement comprising:
a cementitious hydraulic binder;
silica;
a pozzolanic material, wherein the pozzolanic material comprises between 0.25% and 2% of the dry weight of the integrally waterproof fiber cement; and
cellulose fibers, at least some of the cellulose fibers having surfaces that are at least partially treated with a hydrophobic agent to make the surfaces hydrophobic, wherein the dry weight of the hydrophobic agent is between 0.25% and 2% of the weight of the cellulose fibers.

39. The fiber cement article of claim 30, wherein the intermediate portion comprises at least three laminated layers of fiber cement and at least two pigmented layers, and wherein one of the pigmented layers is disposed between each adjacent pair of laminated layers of fiber cement.

40. The fiber cement article of claim 30, wherein the one or more pigmented layers are visible along a cut edge of the fiber cement article when the fiber cement article is cut by a saw perpendicular to the first and second major faces, and wherein the one or more pigmented layers are not visible along the cut edge of the fiber cement article when the fiber cement article is cut by a water jet perpendicular to the first and second major faces.

41. A method of manufacturing a fiber cement article, the method comprising:
forming a first laminate layer of cementitious slurry;
applying a pigment suspension to a first surface of the first laminate layer, the pigment suspension comprising pigment solids suspended in a liquid carrier;
forming a second laminate layer of cementitious slurry over the pigment suspension such that the pigment suspension is disposed between the first laminate layer and the second laminate layer; and
curing the first and second laminate layers and the pigment suspension to form the fiber cement article comprising a cured pigmented layer disposed between two layers of cured fiber cement.

42. The method of claim 41, wherein the pigment suspension comprises an aqueous suspension including particles of a pigment having an average particle size smaller than 50 micron.

43. The method of claim 42, wherein the pigment has an average particle size of between approximately 1 micron and approximately 10 micron.

43. The method of claim 43, wherein the pigment has an average particle size of between approximately 2.5 micron and approximately 7.5 micron.

45. The method of claim 41, wherein the pigment suspension comprises an inorganic pigment.

45. The method of claim 45, wherein the inorganic comprises at least one of an iron oxide, an aluminum oxide, a silicon oxide, or a titanium oxide.

46. The method of claim 46, wherein the inorganic pigment comprises a red iron oxide.

48. The method of claim 41, wherein the first laminate layer and the second laminate layer are formed by first and second sequential passes over one or more sieve cylinders in a Hatschek process.

49. The method of claim 48, wherein the pigment suspension is applied between the first and second sequential passes by depositing the pigment suspension onto a surface of the first laminate layer by one or more of a spray or a slot die, or by passing at least a portion of the first laminate layer through a container of the pigment suspension.

50. The method of claim 41, further comprising, prior to the curing:
applying a second layer of the pigment suspension to a first surface of the second laminate layer; and
forming a third laminate layer of cementitious slurry over the second layer of the pigment suspension such that the second layer of the pigment suspension is disposed between the second laminate layer and the third laminate layer;
wherein the curing simultaneously cures the first, second, and third laminate layers and the pigment suspension to form the fiber cement article comprising two cured pigmented layers alternately disposed between three layers of cured fiber cement.

51-70. (canceled)
